(19) United States
(12) Patent Application Publication
(10) Pub. No.: US 2017/0149936 A1
(43) Pub. Date: May 25, 2017

(54) METHOD, SYSTEM, AND COMPUTER-READABLE RECORDING MEDIUM FOR PROCESSING NETWORK TRAFFIC

(71) Applicant: Electronics and Telecommunications Research Institute, Daejeon (KR)

(72) Inventors: Seong MOON, Daejeon (KR); Ho Yong RYU, Daejeon (KR); Ho Sun YOON, Daejeon (KR); Seung Woo HONG, Daejeon (KR)

(21) Appl. No.: 15/211,414

(22) Filed: Jul. 15, 2016

(30) Foreign Application Priority Data
Nov. 23, 2015 (KR) 10-2015-0163956

(51) Int. Cl. H04L 29/06; H04L 12/46

(52) U.S. Cl. CPC H04L 69/03; H04L 12/4641; H04L 69/16

(57) ABSTRACT

There are provided a method, a system, and a computer-readable recording medium for processing network traffic. A method for processing network traffic using a switching application specific integrated circuit (ASIC) includes generating, by a software forwarder operated in a software-based network operating system, a message including network processing information, transmitting the message to a switch manager operated in a hardware-based network operating system, learning, by the switch manager, the network processing information, and controlling the switching ASIC with reference to the learned information.

### CROSS-REFERENCE TO RELATED APPLICATION

The present application claims priority to Korean patent application number 10-2015-0163956 filed on Nov. 23, 2015, the entire disclosure of which is incorporated herein in its entirety by reference.

### BACKGROUND

1. Field

An aspect of the present disclosure relates to a method, a system, and a computer-readable recording medium for processing network traffic.

2. Description of the Related Art

Software installed in a network device such as a router or a switch to learn network information such as routing or switching, thereby controlling the general functions of the network device, including network traffic, is referred to as a network operating system.

The network operating system may be installed in a predetermined server or virtual machine to operate as a software-based network switch. In addition, the network operating system may be installed in a network hardware switch equipped with an actual network switching application specific integrated circuit (ASIC) to operate in linkage with the switching ASIC.

### SUMMARY

Embodiments provide a method, a system, and a computer-readable recording medium for processing network traffic, in which a module controlling a network switching application specific integrated circuit (ASIC) independently learns changes of network information, so that it is possible to eliminate the dependency between the module and another module in a network operating system.

Embodiments also provide a method, a system, and a computer-readable recording medium for processing network traffic, in which the same software structure can be used regardless of whether a network operating system operates based on software or hardware.

Embodiments also provide a method, a system, and a computer-readable recording medium for processing network traffic, in which the structural dependency of software according to an operation mode of a network operating system is eliminated, so that it is possible to reduce cost for development and maintenance/repair of network operating system software implemented in various forms.

According to an aspect of the present disclosure, there is provided a method for processing network traffic using a switching ASIC, the method including: generating, by a software forwarder operated in a software-based network operating system, a message including network processing information; transmitting the message to a switch manager operated in a hardware-based network operating system; learning, by the switch manager, the network processing information; and controlling the switching ASIC with reference to the learned information.

The message generated by the software forwarder may be an event-based message.

The switch manager may wake up whenever the event-based message is received from the software forwarder in a waiting mode.

The network processing information may include at least one of information on generation or deletion of a bridge, a port added or deleted to or from the bridge, generation or deletion of a virtual local area network (VLAN), a port added or deleted to or from the VLAN, forwarding/blocking of a link, and generation or deletion of a trunk for link aggregation.

The method may further include processing, by the switching ASIC, network traffic received from an external port with reference to the network processing information learned by the switch manager.

According to an aspect of the present disclosure, there is provided a system for processing network traffic, in which a software-based network operating system and a hardware-based network operating system are coupled to each other, the system including: a software forwarder operated in the software-based network operating system, the software forwarder generating a message including network processing information; and a switch manager operated in the hardware-based network operating system, the switch manager learning the network processing information included in the message by receiving the message from the software forwarder, the switch manager controlling a switching ASIC with the learned information.

The software-based network operating system may further include a link manager. The link manager may receive network processing information learned by network protocols and transmit the received network processing information to the software forwarder.

The software forwarder may generate a message including the received information whenever network traffic processing information is received from the link manager, and transmit the generated message to the switch manager. The message may be an event-based message.

The switch manager may wake up whenever the event-based message is received from the software forwarder in a waiting mode.

The network processing information may include at least one of information on generation or deletion of a bridge, a port added or deleted to or from the bridge, generation or deletion of a VLAN, a port added or deleted to or from the VLAN, forwarding/blocking of a link, and generation or deletion of a trunk for link aggregation.

The switching ASIC may process network traffic received from an external port under control of the switch manager.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram schematically illustrating a structure of a network operating system operating based on software.

FIG. 2 is a diagram schematically illustrating a structure of network switch hardware.

FIG. 3 is a diagram illustrating a control structure of a network switching application specific integrated circuit (ASIC) according to a tightly coupled method.

FIG. 4 is a diagram illustrating a control structure of a network switching ASIC according to an embodiment of the present disclosure.

FIG. 5 is a flowchart sequentially illustrating an operation of a software forwarder according to an embodiment of the present disclosure.

FIG. 6 is a flowchart sequentially illustrating an operation of a switch manager according to an embodiment of the present disclosure.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

The embodiments according to the concept of the present disclosure can be variously modified and have various shapes. Thus, the embodiments are illustrated in the drawings and are intended to be described herein in detail. However, the embodiments according to the concept of the present disclosure are not construed as limited to specified disclosures, and include all changes, equivalents, or substitutes that do not depart from the spirit and technical scope of the present disclosure.

While terms such as “first” and “second” may be used to describe various components, such components must not be understood as being limited to the above terms. The above terms are used only to distinguish one component from another. For example, a first component may be referred to as a second component without departing from the scope of rights of the present disclosure, and likewise a second component may be referred to as a first component.

It will be understood that when an element is referred to as being “connected” or “coupled” to another element, it can be directly connected or coupled to the other element or intervening elements may also be present. In contrast, when an element is referred to as being “directly connected” or “directly coupled” to another element, no intervening elements are present. Meanwhile, other expressions describing relationships between components such as “˜between,” “immediately˜between” or “adjacent to˜” and “directly adjacent to˜” may be construed similarly.

The terms used in the present application are merely used to describe particular embodiments, and are not intended to limit the present disclosure. Singular forms in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

So far as not being differently defined, all terms used herein including technical or scientific terminologies have meanings that they are commonly understood by those skilled in the art to which the present disclosure pertains. The terms having the definitions as defined in the dictionary should be understood such that they have meanings consistent with the context of the related technique. So far as not being clearly defined in this application, terms should not be understood in an ideally or excessively formal way.

Hereinafter, exemplary embodiments of the present disclosure will be described in detail with reference to the accompanying drawings. For better understanding of the present disclosure, like components are designated by like reference numerals, and descriptions of like components are omitted to avoid redundancy.

In the present disclosure, software installed in a network device such as a router or a switch to learn network information such as routing or switching, thereby controlling the general functions of the network device, including network traffic, is referred to as a network operating system.

The network operating system may be installed in a predetermined server or virtual machine to operate as a software-based network switch. In addition, the network operating system may be installed in a network hardware switch equipped with an actual network switching application specific integrated circuit (ASIC) to operate in linkage with the switching ASIC.

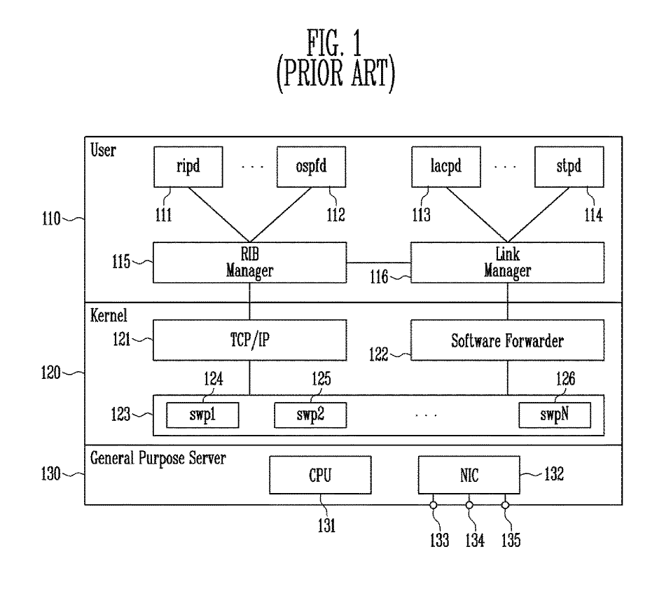

FIG. 1 is a diagram schematically illustrating a structure of a network operating system operating based on software.

In this specification, the term “operating based on software” means that a transfer control protocol/Internet protocol (TCP/IP) stack 121 and a software forwarder 122 in a kernel 120 process network traffic in software manner without using dedicated hardware for processing the network traffic.

Network protocols 111, 112, 113, and 114 as communication protocols for regulating communications among routers may be installed in the network operating system. The network protocols 111, 112, 113, and 114 may learn network information through learning with a corresponding network device.

The network protocols may be a set of daemons such as a routing information protocol daemon (ripd) using a distance vector protocol, an open short path first daemon (ospf) using a link state protocol, a link aggregation control protocol daemon (lacpd), and a spanning tree protocol daemon (stpd).

Next, manager modules 115 and 116 for controlling routing and switching of actual network traffic on the basis of information learned by the network protocols 111, 112, 113, and 114 may be installed in the network operating system.

The manager modules 115 and 116 may be at least one of a route information base (RIB) manager 115 and a link manager 116.

The RIB manager 115 functions to process Layer-3 routing information, and transmits the processed routing information to the TCP/IP stack 121 of the kernel area 120.

The link manager 116 functions to process Layer-2 switching information, and transmits the processed switching information to the software forwarder 122 of the kernel area 120.

The TCP/IP stack 121 and the software forwarder 122 in the kernel 120 may use a network interface such as a switch port (swp) for traffic transmission/reception to/from an outside thereof.

Meanwhile, in this specification, the term “operating based on software” may mean that the TCP/IP stack 121 and the software forwarder 122 in the kernel 120 process network traffic in software manner without using dedicated hardware for processing the network traffic.

An operating mode based on software as described above may be frequently used in development of a network operating system. For example, a network operating system may be installed in a virtual machine to be used in a linkage test with a plurality of network nodes.

As described above with reference to FIG. 1, any special dedicated hardware is not required when the network operating system operates based on software, and a server 130 equipped with a predetermined central processing unit (CPU) 131 may be used.

The CPU 131 may be an x86 series CPU. However, the present disclosure is not limited thereto, and any capable of functioning to execute program commands may serve as the CPU 131 of the present disclosure.

The server 130 may include a network interface card (NIC) 132 for communication with an outside thereof. The server 130 may transmit/receive network traffic through ports 133, 134, and 135 of the NIC 132.

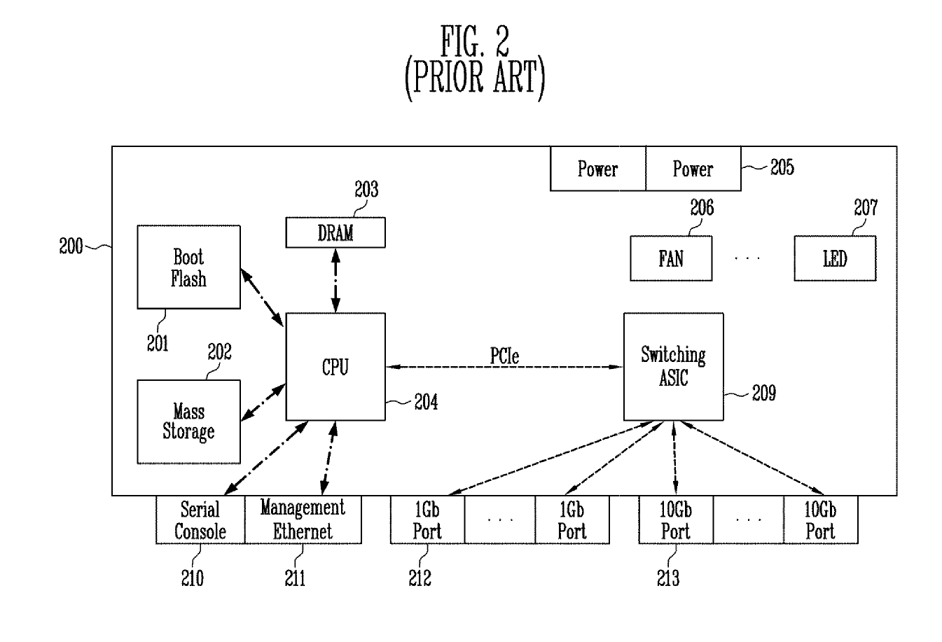

Hereinafter, a case where the network operating system is installed in a network hardware switch to operate in linkage with a switching ASIC will be described with reference to FIG. 2.

FIG. 2 is a diagram schematically illustrating a structure of network switch hardware.

Referring to FIG. 2, the network switch hardware 200 may include a CPU 204, storage devices 201 and 202, a memory 203, a power supply device 205, a cooling fan 206, an LED 207, and the like.

The storage devices 201 and 202 may be a boot flash and a mass storage. The memory 203 may be a dynamic random access memory (DRAM).

The network switch hardware 200 may further include a switching ASIC 209 for functioning to process network traffic at high speed. The network switch hardware may transmit/receive network traffic to/from external ports 212 and 213 through the switching ASIC 209.

When a network operating system is operated on the network switch hardware 200 equipped with the switching ASIC 209 for processing network traffic, high-speed traffic processing is possible as compared with a network operating system operating only based on software.

Meanwhile, the network switch hardware 200 may further include a console 210 and a management port 211, through which a predetermined manager can access the network switch hardware 200.

Network traffic processing information learned by an actual network operating system is transmitted to the switching ASIC 209 by network operating system software installed in the CPU 204.

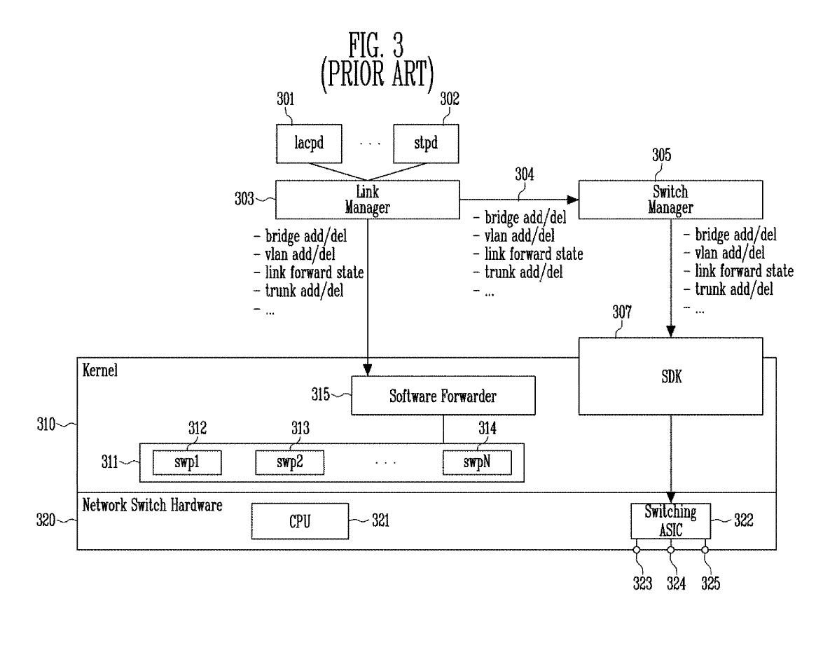

In a method for transmitting, to the switching ASIC 209, traffic processing information learned by network protocols, a tightly coupled method was typically used as shown in FIG. 3.

FIG. 3 is a diagram illustrating a control structure of a network switching ASIC according to a tightly coupled method.

Referring to FIG. 3, if Layer-2 related network processing information is learned by network protocols 301 and 302 such as an lacp and an stp, processing modules of the network protocols 301 and 302 transmit the learned Layer-2 related network processing information to a link manager 303.

The link manager 303 transmits, to a software forwarder 315 of a kernel 310, the Layer-2 related network processing information acquired from the processing modules of the network protocols 301 and 302 such as the lacp and the stp. In addition, the link manager 303 may transmit, to a switch manager 305, information equal to that transmitted to the software forwarder 315.

Alternatively, the processing modules of the network protocols 301 and 302 such as the lacp and the stp does not transmit the learned Layer-2 related network processing information to the link manager 303 but may directly transmit the learned Layer-2 related network processing information to the software forwarder 315.

Meanwhile, the network processing information transmitted to the software forwarder 315 and the switch manager 305 may include information on generation/deletion of a new bridge, addition/deletion of a specific port to/from the bridge, generation/deletion of a virtual local area network (VLAN), addition/deletion of a specific port to/from the VLAN, forwarding/blocking of a link, generation/deletion of a trunk for link aggregation, and the like.

The switch manager 305 may transmit the network processing information received from the link manager 303 to a network switching ASIC 322 through a software development kit (SDK) 307. The network switching ASIC 322 processes network traffic received from external ports 323, 324, and 325 with reference to the network processing information transmitted from the switch manager 305.

However, the above-described network operating system normally operates in only a hardware-based network operating system equipped with the network switching ASIC 322, and the same network operating system cannot operate based on software.

That is, in order to operate the network operating system based on software, a new network operating system is to be developed and released, and therefore, the development and maintenance/repair of source codes are complicated.

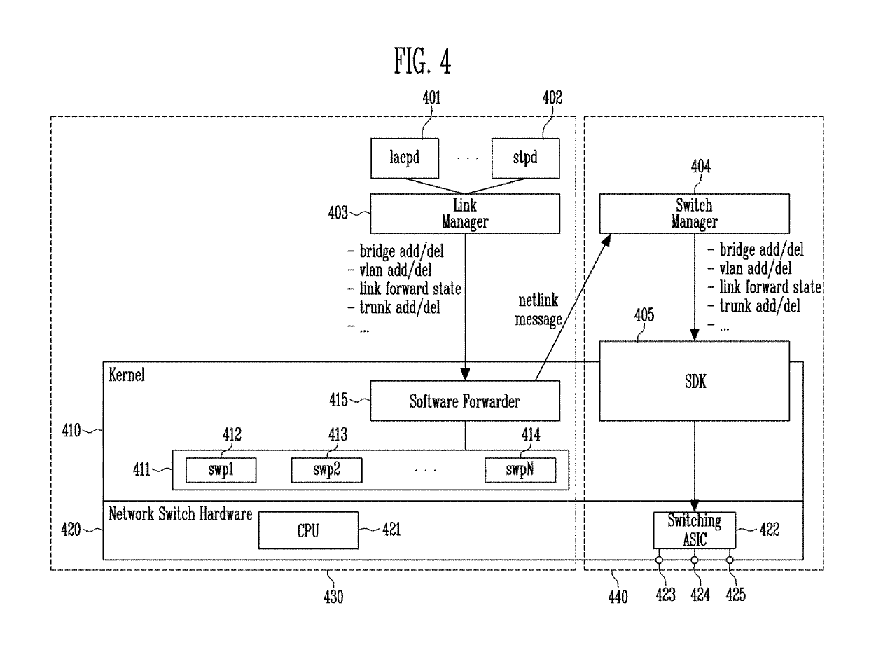

FIG. 4 is a diagram illustrating a control structure of a network switching ASIC according to an embodiment of the present disclosure.

Network protocols 401 and 402 such as an lacp and an stp learn how to process network traffic through learning with a corresponding network device.

A link manager 403 transmits, to a software forwarder 415, network processing information learned by the network protocols 401 and 402.

In this case, the network processing information transmitted to the software forwarder 415 may include information on generation/deletion of a new bridge, addition/deletion of a specific port to/from the bridge, generation/deletion of a VLAN, addition/deletion of a specific port to/from the VLAN, forwarding/blocking of a link, generation/deletion of a trunk for link aggregation, and the like.

The software forwarder 415 may function to process network traffic with reference to the above-described information.

When the network operating system according to the present disclosure operates based on software, a software-based network operating system structure 430 may not be linked with a switch manager 404, an SDK 405, and a switching ASIC 422, which are included in a hardware-based network operating system structure 440, in the operation of the entire network operating system.

Therefore, the network operating system may operate based on software using only components in the software-based network operating system structure 430, i.e., the network protocols 401 and 402, the link manager 403, the software forwarder 415, and the like.

Meanwhile, linkage between the software-based network operating system structure 430 and the switching ASIC 422 is required to operate the network operating system based on software. In this case, the switching ASIC 422 may operate in linkage with the software-based network operating system structure 430 through the switch manager 404.

The switch manager 404 may receive information required for switching ASIC 422 to process network traffic, which are provided from the software forwarder 415.

Whenever network traffic processing information is received from upper layer processors, the software forwarder 415 generates a message including the received information and transmits the generated message to the switch manager 404. Here, the message may be a netlink message.

The netlink message transmitted to the switch manager 404 by the software forwarder 415 may include information on generation/deletion of a new bridge, addition/deletion of a specific port to/from the bridge, generation/deletion of a VLAN, addition/deletion of a specific port to/from the VLAN, forwarding/blocking of a link, generation/deletion of a trunk for link aggregation, and the like.

Meanwhile, in this specification, the term ‘netlink message communication method’ means a communication method characterized in that a receive is not continuously check whether a message has arrived in reception of the message, but, if an event notifying that a message has arrived occurs while the receiver is waiting for reception of the message in a waiting mode, can read and process the message. That is, the netlink message may be an event-based message.

Thus, the switch manager 404 can process the netlink message by waking up when there occurs an event notifying that the netlink message has been received from the software forward 415 in the waiting mode.

According to the present disclosure, the switch manager 404 does not rely on the components included in the software-based network operating system structure 430, including the network protocols 401 and 402 such as the lacp and stp, the link manager 403, and the like, and can learn, for itself, information for processing network traffic.

The switch manager 404 may transmit the learned information to the switching ASIC 422 through the SDK 405. The switching ASIC 422 may process network traffic received from external ports 423, 424, and 425 with reference to the network processing information learned by the switch manager 404.

According to the present disclosure, the switching manager 404 controlling the switching ASIC 422 learns network processing information to be recognized by itself, independently from the protocols 401 and 402 learning network information and the link manager 403, and thus it is unnecessary for the protocols 401 and 402 learning the network information, the link manager 403, and the software forwarder 415 to determine information on whether they operate based on software or hardware.

That is, the components in the software-based network operating system structure 430 can operate regardless of whether they operate based on software or hardware. Thus, when the network operating system is to be operated based on hardware, only the hardware-based network operating system structure 440 is added, and it is unnecessary to newly develop a separate network operating system.

In other words, when the network operating system is to be operated based on hardware, only a subsystem for the hardware-based network operating system is added, so that it is possible to eliminate the dependency between the components of the network operating system.

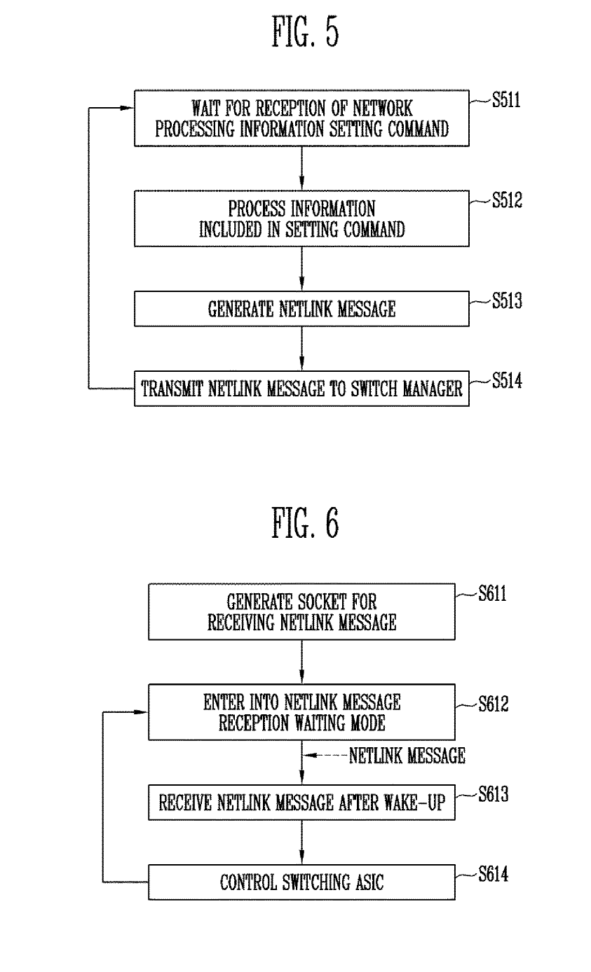

FIG. 5 is a flowchart sequentially illustrating an operation of a software forwarder according to an embodiment of the present disclosure.

First, the software forwarder finishing a predetermined initialization process waits for the reception of a network processing information setting command (S511).

The network processing information setting command may include setting commands for a bridge, a VLAN, a link, a trunk, and the like. More specifically, each setting command may include information on generation/deletion of a new bridge, addition/deletion of a specific port to/from the bridge, generation/deletion of a VLAN, addition/deletion of a specific port to/from the VLAN, forwarding/blocking of a link, generation/deletion of a trunk for link aggregation, and the like.

If a setting command is received, the software forwarder processes information included in the setting command (S512).

Next, the software forwarder generates a netlink message containing the information included in the setting command (S513), and transmits the generated netlink message to a switch manager (S514).

FIG. 6 is a flowchart sequentially illustrating an operation of a switch manager according to an embodiment of the present disclosure.

First, the switch manager generates a socket capable of receiving a netlink message (S611), and enters into a netlink message reception waiting mode (S612).

If a software forwarder transmits a netlink message when the switch manager is in a waiting mode state, the switch manager receives the netlink message by waking up (S613).

That is, the switch manager does not continuously or periodically check whether a message has arrived. If an event notifying that a message has arrived occurs, the switch manager wakes up.

Next, the switch manager controls a switching ASIC with reference to network processing information included in the message (S614).

The network processing information may include information on generation/deletion of a new bridge, addition/deletion of a specific port to/from the bridge, generation/deletion of a VLAN, addition/deletion of a specific port to/from the VLAN, forwarding/blocking of a link, generation/deletion of a trunk for link aggregation, and the like.

The embodiments according to the present disclosure described above can be implemented in the form of program commands that can be executed through various computer components and recorded in a computer-readable recording medium. The computer-readable recording medium may include a program command, a data file, a data structure, and the like solely or in a combined manner. The program command recorded in the computer-readable recording medium may be a program command specially designed and configured for the present disclosure or a program command known to be used by those skilled in the art of the computer software field. The computer-readable recording medium includes, for example, a magnetic medium, such as a hard disk, a floppy disk and a magnetic tape, an optical recording medium, such as a CD-ROM and a DVD, a magneto-optical medium, such as a optical disk, and a hardware device specially configured to store and execute program commands, such as a ROM, a RAM, and a flash memory. The program command includes, for example, a high-level language code that can be executed by a computer using an interpreter or the like, as well as a machine code generated by a compiler. The hardware devices can be configured to operate using one or more software modules in order to perform the processing according to the present disclosure, and vice versa.

According to the present disclosure, the components in the network operating system are equally operated regardless of when the network operating system is installed in a predetermined server or virtual machine to be operated based on software and when the network operating system is operated based on hardware equipped with a switching ASIC, so that it is possible to reduce cost required to develop and maintain/repair network operating system software.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A method for processing network traffic using a switching application specific integrated circuit (ASIC), the method comprising:
generating, by a software forwarder operated in a software-based network operating system, a message including network processing information;
transmitting the message to a switch manager operated in a hardware-based network operating system;
learning, by the switch manager, the network processing information; and
controlling the switching ASIC with reference to the learned information.

2. The method of claim 1, wherein the message generated by the software forwarder is an event-based message.

3. The method of claim 2, wherein the switch manager wakes up whenever the event-based message is received from the software forwarder in a waiting mode.

4. The method of claim 1, wherein the network processing information includes at least one of information on generation or deletion of a bridge, a port added or deleted to or from the bridge, generation or deletion of a virtual local area network (VLAN), a port added or deleted to or from the VLAN, forwarding/blocking of a link, and generation or deletion of a trunk for link aggregation.

5. The method of claim 1, further comprising processing, by the switching ASIC, network traffic received from an external port with reference to the network processing information learned by the switch manager.

6. A system for processing network traffic, in which a software-based network operating system and a hardware-based network operating system are coupled to each other, the system comprising:
a software forwarder operated in the software-based network operating system, the software forwarder generating a message including network processing information; and
a switch manager operated in the hardware-based network operating system, the switch manager learning the network processing information included in the message by receiving the message from the software forwarder, the switch manager controlling a switching ASIC with the learned information.

7. The system of claim 6, wherein the software-based network operating system further includes a link manager, and
the link manager receives network processing information learned by network protocols and transmits the received network processing information to the software forwarder.

8. The system of claim 7, wherein the software forwarder generates a message including the received information whenever network traffic processing information is received from the link manager, and transmits the generated message to the switch manager, and
the message is an event-based message.

9. The system of claim 8, wherein the switch manager wakes up whenever the event-based message is received from the software forwarder in a waiting mode.

10. The system of claim 6, wherein the network processing information includes at least one of information on generation or deletion of a bridge, a port added or deleted to or from the bridge, generation or deletion of a VLAN, a port added or deleted to or from the VLAN, forwarding/blocking of a link, and generation or deletion of a trunk for link aggregation.

11. The system of claim 10, wherein the switching ASIC processes network traffic received from an external port under control of the switch manager.
